(19) United States
(12) Patent Application Publication
(10) Pub. No.: US 2023/0303842 A1
(43) Pub. Date: Sep. 28, 2023

(54) BLOCK-COPOLYMER DISPERSANTS IN STYRENE BUTADIENE RUBBER (SBR) LATEXES FOR USE IN ASPHALT EMULSION APPLICATIONS

(71) Applicant: BASF SE, Ludwigshafen am Rhein (DE)

(72) Inventors: William J. KIRK, Charlotte, NC (US); Kostas S. AVRAMIDIS, Charlotte, NC (US)

(21) Appl. No.: 18/124,661

(22) Filed: Mar. 22, 2023

Related U.S. Application Data
(60) Provisional application No. 63/323,687, filed on Mar. 25, 2022.

(51) Int. Cl. C08L 95/00; C08F 265/04; C08L 9/08

(52) U.S. Cl. CPC C08L 95/005; C08F 265/04; C08L 9/08; C08L 2201/54

(57) ABSTRACT

Disclosed herein are asphalt compositions containing a block-copolymer additive, for example for use as a dispersant. In some embodiments, the asphalt compositions can include asphalt, a block-copolymer dispersant, and an SBR latex. The block-copolymers have a molecular weight exceeding 5000 g/mol with a polybutyl acrylate hydrophobic block that attaches to the asphalt particle and a sodium polystyrene sulfonate hydrophilic block for stability, wherein the block copolymer has a first block comprising of alkyl acrylate and a second block comprising units of an ethylenically unsaturated monomer with sulfonic acid groups.

The asphalt compositions can include asphalt in an amount of from 50 wt. % to 95 wt. %, based on the weight of the asphalt composition. In some embodiments, the asphalt compositions can include a styrene-butadiene copolymer in an amount of from 0.05 wt. % to 10 wt. %, based on the weight of the asphalt composition. Methods of making and using the asphalt compositions are also disclosed.

### FIELD OF THE DISCLOSURE

This disclosure relates generally to asphalt emulsion compositions, and more particularly to asphalt compositions that include a block-copolymer (BCP) dispersant, and to methods of making and using the polymer-modified asphalt emulsions.

### BACKGROUND OF THE DISCLOSURE

Asphalt compositions have a wide number of applications, including but not limited to the production of aggregate pavement. The properties of asphalt may be improved by the incorporation of a block-copolymer dispersant. The addition of the polymer can improve adhesion, ductility, tensile strength, durability, and cold temperature properties of the asphalt. Polymer modified asphalt compositions can be prepared by melting the asphalt and adding a polymer to the molten asphalt. However, this process is energy intensive. Alternately, polymer modified asphalt compositions can be prepared by mixing emulsions of asphalts with a latex of the polymer. While this process is less energy intensive, it increases the delay in setting times and drying times of asphalt emulsions. This delay is extremely expensive when traffic must be kept off a lane of a highway for a lengthy period of time. Another problem encountered is that the asphalt emulsion may get too fluid and can separate from the aggregate, reducing the lifetime of the pavement. There is a need for asphalt compositions with better adhesion to aggregates, setting times, and viscosity. The compositions and methods described herein address these and other needs.

### SUMMARY OF THE DISCLOSURE

Disclosed herein are asphalt compositions. In some embodiments, the asphalt compositions can include an asphalt emulsion, such as an emulsion containing a block-copolymer (BCP) dispersant. The block-copolymers have a molecular weight of over 5000 g/mol with a polybutyl acrylate hydrophobic block and a sodium polystyrene sulfonate hydrophilic block. The hydrophobic block attaches to the asphalt particle and the hydrophilic block provides stability. The composition can be polymerized at a low temperature at less than 25° C. and have a butadiene/styrene monomer ratio of 75/25.

Methods of making and using the asphalt compositions are also disclosed. The method can include mixing asphalt, an aqueous dispersion, and the block-copolymer. Methods of coating a surface comprising applying an asphalt composition as described herein to the surface are also disclosed herein.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 provides the average particle size and distribution of the asphalt emulsion with [BN 4190+3 parts BCP]. The distribution demonstrates a much narrower emulsion droplet size with 3% BCP as compared to the BN 4190 control.

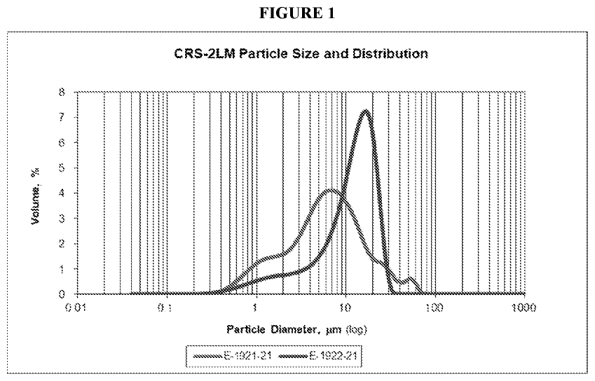

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Disclosed herein are asphalt compositions. In some embodiments, the asphalt composition can include asphalt, an aqueous dispersion, and a block-copolymer additive. Methods of making and using the compositions described herein are also disclosed.

The term “asphalt” as used herein, includes the alternative term “bitumen.” Thus, the asphalt compositions can be termed bitumen compositions. “Asphalt composition” as used herein, include asphalt emulsions and hot-mix asphalt compositions. The asphalt can be molten asphalt. The asphalt compositions can include 50% or greater by weight of the asphalt compositions, of asphalt. In some embodiments, the asphalt compositions can include 55% or greater, 60% or greater, 65% or greater, 70% or greater, 75% or greater, 80% or greater, 85% or greater, 90% or greater, 95% or greater, or 99% or greater by weight of the asphalt compositions, of asphalt. In some embodiments, the asphalt compositions can include 99.9% or less, 99% or less, 95% or less, 90% or less, 87% or less, 85% or less, 83% or less, or 80% or less by weight of the asphalt compositions, of asphalt. In some embodiments, the asphalt compositions can include 50% to 95%, 50% to 90%, 50% to 85%, 50% to 80%, 60% to 95%, 60% to 90%, or 60% to 80% by weight of the asphalt compositions, of asphalt.

As described herein, the asphalt compositions include a block-copolymer additive. This block-copolymer additive may act, for example, as a dispersant. This block-copolymer may be, for example, a block-copolymer containing a hydrophobic block that attaches to particles in the asphalt and a hydrophilic block that provides stability. The hydrophobic block may, for example, be an acrylate hydrophobic block, particularly a polyalkyl acrylate hydrophobic block, in more particular a polybutyl acrylate hydrophobic block. The hydrophilic block may, for example, be a vinylaromatic hydrophilic block, in particular a polystyrene block, in more particular a polystyrene sulfonate block. This hydrophilic block may, for example, be a sodium polystyrene sulfonate hydrophilic block. In one embodiment, the copolymer is a block-copolymer with a polybutyl acrylate hydrophobic block and a sodium polystyrene sulfonate hydrophilic block.

The resulting block-copolymer is optionally of the formula (III):

X—[A]ₐ—[B]_{b}—Z (III), wherein

[A] is polymer block composed of alkyl acrylate, for example n-butylacrylate, and
a is an integer which indicates the number of monomers units in the polymer block [A], a being 10 to 80, for example 10 to 40,
[B] is a homopolymer block or a copolymer block composed of an ethylenically unsaturated monomer with sulfonic acid groups, for example sodium styrene sulfonic acid, and optional comonomers and
b is an integer which indicates the number of monomers units in the polymer block [B], b being 10 to 80, with the proviso that the molar ratio of polymer block [A] to polymer block [B] is 1:1 to 8:1,
X is selected from the group consisting of —CH₂-phenyl, —CHCH₃-phenyl, —C(CH₃)₂-phenyl, —C(C₅-C₆-cycloalkyl)₂—CN, —C(CH₃)₂CN, —CH₂CH═CH₂, —CH₃CH—CH═CH₂, —(C₁-C₄alkyl)CR⁷—C(O)-phenyl, —(C₁-C₄)alkyl—CR⁷—C(O)—(C₁-C₄)alkoxy, —(C₁-C₄)alkyl-CR⁷—C(O)—(C₁-C₄)alkyl, —(C₁-C₄)alkyl—CR⁷—C(O)—N-di(C₁-C₄)alkyl, —(C₁-C₄)alkyl-C⁷—C(O)—NH(C₁-C₄)alkyl, and —(C₁-C₄)alkyl-CR⁷—C(O)—NH₂, wherein
R⁷ is hydrogen or (C₁-C₄)alkyl and
Z is the terminal group of the block-copolymer, defined below.

The block-copolymer of the present invention is prepared by controlled free radical polymerization of at least 80 wt. % based on the weight of the monomers of the [A] block of alkyl acrylate, preferably n-butyl acrylate, which builds the first block and monomers comprising at least a sulfonic acid groups bearing ethylenically unsaturated monomers which builds the second block ([B] block).

The first block comprises at least 80 wt. % units of alkyl acrylate. This means that this first block is composed to an extent of at least 80 wt. %, more particularly at least 90 wt. %, especially at least 95 wt. %, or at least 99 wt. %, based on [A], respectively based on the total amount of the constituent monomers M of the polymer block [A], or entirely, of alkyl acrylate.

Suitable alkyl acrylates are esters of monoethylenically acrylic acid with C₄-C₂₀-alkanols, examples being n-butyl acrylate, 2-butyl acrylate, isobutyl acrylate, tert-butyl acrylate, n-hexyl acrylate, 2-ethylhexyl acrylate, 3-propylheptyl acrylate, decyl acrylate, lauryl acrylate and stearyl acrylate. Preferred is n-butylacrylate.

As additional monomers of the first block it is possible to use for example styrene, C₁-C₄ alkyl substituted styrene, hydroxyalkyl esters of the α,β-unsaturated C₃-C₆ carboxylic acids, for example 2-hydroxyethyl acrylate, 3-hydropxypropyl acrylate, 4-hydroxybutyl acrylate, hydroxyethyl methacrylate, hydroxypropyl methacrylate, polyethylene glycol mono(meth)acrylate where poly-ethylene glycol vary from 1-22 repeating units or mixtures thereof. If these additional monomers are present, they are present in an amount up to 20 wt. %, preferably up to 10 wt. %, especially up to 5 wt. %.

The second block comprises units of the ethylenically unsaturated monomer with sulfonic acid groups. This means that this second block is composed to for example an extent of at least 20 wt. %, more particularly at least 50 wt. %, especially at least 80 wt. %, or at least 90 wt. %, based on [B], respectively based on the total amount of the constituent monomers M of the polymer block [B], or entirely, of monoethylenically unsaturated monomers with sulfonic acid groups.

Suitable ethylenically unsaturated monomers with sulfonic acid groups are for example vinylsulfonic acid, 4-styrene sulfonic acid, 2-acrylamido-2-methylpropane sulfonic acid, sulfopropyl acrylate and sulfopropyl methacrylate. The ethylenically unsaturated monomer with sulfonic acid groups can be used as monomers in the form of the free acid as well as in their partially or completely neutralized form. For example, sodium hydroxide, potash or ammonia is used as a neutralizing agent. For example, styrene sulfonic acid and its alkali or ammonium salts may be used, especially sodium styrene sulfonate.

As additional monomers of the second block it is possible to use the amides and the hydroxy-alkyl esters of the α,β-unsaturated C₃-C₆ carboxylic acids, for example acrylamide, methacrylamide, 2-hydroxyethyl acrylate, 2-hydroxyethyl methacrylate, 2-hydroxypropyl (meth)acrylate or 1,4-butanediol monoacrylate, α,β-unsaturated C₃-C₆ carboxylic acids, α,β-unsaturated C₄-C₈ di-carboxylic acids, or anhydrides thereof, such as acrylic acid, methacrylic acid, crotonic acid, fumaric acid, maleic acid, maleic anhydride, itaconic acid, and itaconic anhydride, and also the alkali metal salts or ammonium salts of the stated monomers, especially their sodium salts.

Furthermore, esters of monoethylenically unsaturated C₃-C₆ monocarboxylic acids with polyether monools, more particularly with C₁-C₂₀ alkylpoly-C₂-C₄ alkylene glycols, especially with C₁-C₂₀ alkylpolyethylene glycols, the alkylpolyalkylene glycol radical typically having a molecular weight in the range from 200 to 5000 g/mol (numerical average), more particularly the aforementioned esters of acrylic acid and also the aforementioned esters of methacrylic acid are suitable.

Furthermore, N-vinylpyrrolidone, phosphate esters of polyethylene glycol mono(meth)acrylate and its water-soluble salts where polyethylene glycol vary from 1-22 repeating units can be used.

Since the alkyl acrylate is a hydrophobic group whereas the sulfonic acid groups bearing ethylenically unsaturated monomer is a hydrophilic group the block-copolymer is an amphiphilic substance.

The block-copolymer of the invention may, for example, have a terminal group of the formula Z in which,

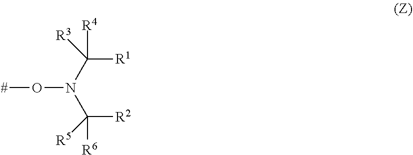

# denotes the attachment to a C atom of the polymer block,
R¹ and R² independently of one another are C₁-C₂₀ alkyl which optionally carries substituent selected from C₁-C₄ alkoxy, C₁-C₄ alkoxy-C₁-C₄ alkoxy and PO₃R^{z}₂, and R^{z} is C₁-C₄ alkyl, or are phenyl or are C₇-C₁₈ aralkyl or R¹ and R² together are linear C₂-C₁₀ alkylene or linear C₂-C₁₀ alkenylene in which optionally one or two CH₂ groups may have been independently of another replaced by O, C═O, C═NOH, CH—OCOCH₃ or NR^{x}, where linear C₂-C₁₀ alkylene and linear C₂-C₁₀ alkenylene are unsubstituted or have 1, 2, 3, 4 or 5 substituents from the group C₁-C₄ alkyl, C₁-C₄ alkoxy, C₁-C₄ alkoxy-C₁-C₄ alkoxy, COOH, and CONH₂, and R^{x} is C₁-C₄ alkyl or C₁-C₄ alkoxy;
R³ is C₁-C₄ alkyl or H,
R⁴, R⁵, and R⁶ independently of one another are C₁-C₄ alkyl, and more particularly methyl or ethyl.

In formula Z optionally R¹ and R² together are linear C₂-C₁₀ alkylene, in which, optionally, one or two CH₂ groups may have been replaced by O, C═O and/or NR^{x}, and where linear C₂-C₁₀ alkylene is unsubstituted or has 1, 2, 3, or 4 substituents from the group of C₁-C₄ alkyl, C₁-C₄ alkoxy, C₁-C₄ alkoxy-C₁-C₄ alkoxy, COOH, and CONH₂, and R^{x} is C₁-C₄ alkyl or C₁-C₄ alkoxy.

In formula Z more particularly R¹ and R² together are linear C₂-C₄ alkylene and especially are 1,3-propanediyl, in which optionally one or two CH₂ groups may have been replaced by O, C(═O), or NR^{x}, where linear C₂-C₄ alkylene or 1,3-propanediyl is unsubstituted or has 1, 2, 3, or 4 substituents from the group of C₁-C₄ alkyl and C₁-C₄ alkoxy, and R^{x} is C₁-C₄ alkyl, especially methyl.

In an embodiment of the presently claimed invention, the stable free nitroxyl radical is selected from the group consisting of radicals with the formula Za, Zb, Zc, Zd, Ze, Zf, Zg, and Zh

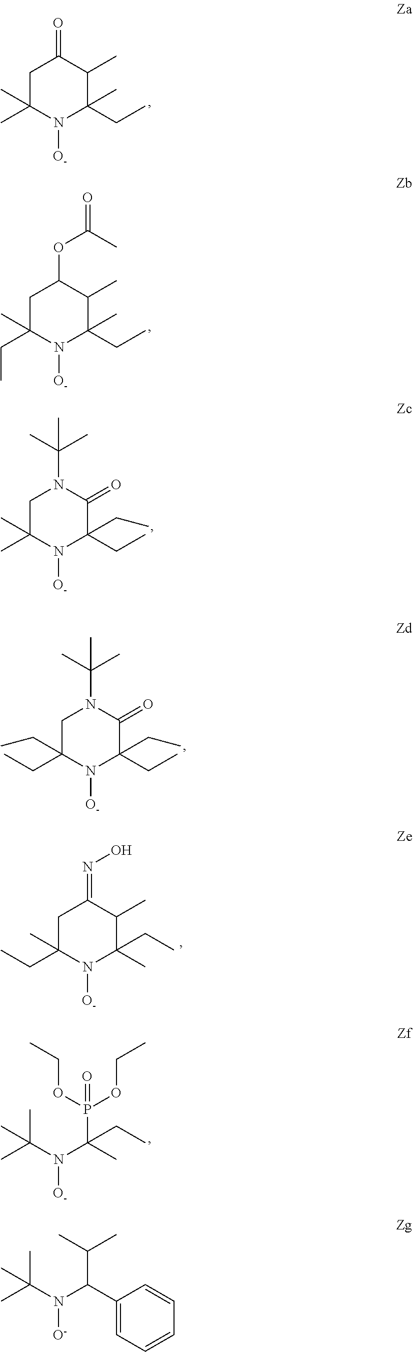

In an additional embodiment, the at least one stable free nitroxyl radical is of the formula Ze or Zh:

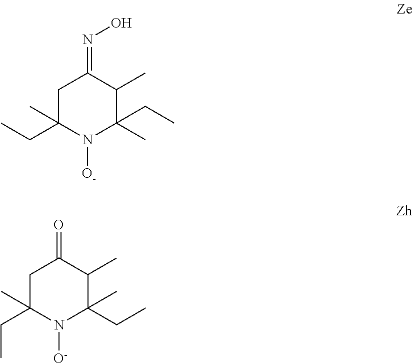

The block-copolymers of the invention may have a number-average molecular weight Mₙ in the range from 1,500 to 200,000 g/mol, more particularly 2,000 to 100,000 g/mol. The weight-average molecular weight M_{w} of the block-copolymers of the invention is situated typically in the range from 2,500 to 30,000 g/mol and more particularly in the range from 3,000 to 10,000 g/mol. The polydispersity, i.e., the ratio M_{w}/Mₙ, is situated typically in the range from 1 to 2 and more particularly in the range from 1.2 to 1.6.

The block-copolymer may have ≤80 especially ≤60 and ≥5, especially ≤40 and ≥10 average repeating units in Block [A], optionally entirely of the alkyl acrylate. Examples are block-copolymers with 15 to 60 average repeating units of the alkyl acrylate, which consist of more than 90% by mol of n-butylacrylate. Optionally they are block-copolymers with 15 to 40 average repeating units of the alkyl acrylate, which consist of more than 90% by mol of n-butylacrylate.

Block-copolymers may be used wherein the second block consists of ≤80 especially ≤70 and ≥5, especially ≥10 average monomer units in total. These monomer units are composed to an extent of at least 20 wt. %, more particularly at least 50 wt. %, especially at least 80 wt. %, or at least 90 wt. %, based on the total amount of the constituent monomers M of the second polymer block, or entirely, of monoethylenically unsaturated monomers with sulfonic acid groups.

The molar ratio of the monomers of polymer block [A] to the monomer of polymer block [B] may be 1:1 to 8:1, for example 1:1 to 6:1, especially 1:1 to 2.5:1. This equals the ratio of the number of the units. The block-copolymer optionally has a first block of n-butyl acrylate units and a second block of styrene sulfonic acid and/or its salts units and the number of units of the first block (block [A]) and to the number of units of the second block (block [B]) is in the ratio of 1:1 to 8:1, for example 1:1 to 2.5:1.

One method for providing the block-copolymer of the present invention is that of controlled radical polymerization by the NMP method (nitroxide-mediated polymerization). Suitable nitroxylethers and nitroxyl radicals are principally known from U.S. Pat. No. 4,581,429 or EP-A-621 878. Particularly useful are the open chain compounds described in WO 98/13392 (Akzo), WO 99/03894 (Ciba) and WO 00/07981 (Ciba), the piperidine derivatives described in WO 99/67298 (Ciba) and GB 2335190 (Ciba) or the heterocyclic compounds described in GB 2342649 (Ciba) and WO 96/24620 (Atochem). Further suitable nitroxylethers and nitroxyl radicals are described in WO 02/4805 (Ciba) and in WO 02/100831 (Ciba). Each of these references is incorporated herein by reference in their entirety.

According to the invention, the block-copolymers described above are used as an aid for the preparation of aqueous polymer dispersions, which are characterized by a particularly pure water phase.

The block-copolymer additive according to the invention is present in the asphalt composition in an amount from about 0.003 to 3% by weight, in particular from about 0.05 to 2% by weight, in particular from about 0.01 to 1% by weight, in particular from about 0.1 to about 1% by weight, particularly about 0.1% by weight based on the weight of the asphalt composition.

In addition, as described herein, the asphalt compositions can include a polymer. In some embodiments, the polymer can be derived from ethylenically unsaturated monomers. For example, the polymer can be a pure acrylic polymer (i.e., a polymer derived exclusively from (meth)acrylate and/or (meth)acrylic acid monomers), a styrene-butadiene copolymer (i.e., a polymer derived from butadiene and styrene monomers), a styrene-butadiene-styrene block-copolymer, a vinyl aromatic-acrylic copolymer (i.e., a polymer derived from vinyl aromatic monomers such as styrene and one or more (meth)acrylate and/or (meth)acrylic acid monomers), a vinyl-acrylic copolymer (i.e., a polymer derived from one or more vinyl ester monomers and one or more (meth)acrylate and/or (meth)acrylic acid monomers), a vinyl chloride polymer (i.e., a polymer derived from one or more vinyl chloride monomers), a vinyl alkanoate polymer (i.e., a polymer derived from one or more vinyl alkanoate monomers, such as polyvinyl acetate or a copolymer derived from ethylene and vinyl acetate monomers), or a combination thereof. The term “(meth)acryl . . . ,” as used herein, includes “acryl . . . ,” “methacryl . . . ,” or mixtures thereof. The polymer can be a random copolymer or a block-copolymer. In some embodiments, the polymer can include a styrene-butadiene copolymer, polychloroprene, a styrene-butadiene-styrene block-copolymer, an ethylene vinyl acetate copolymer, a styrene acrylic copolymer, an acrylic polymer, a vinyl acrylic copolymer, or a combination thereof.

Suitable unsaturated monomers for use in forming the polymer are generally ethylenically unsaturated monomers and include vinylaromatic compounds (e.g. styrene, α-methylstyrene, o-chlorostyrene, and vinyltoluenes); 1,2-butadiene (i.e. butadiene); conjugated dienes (e.g. 1,3-butadiene and isoprene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile; vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate).

The polymer can include one or more additional monomers. The additional monomers can include, for example, other vinyl aromatic compounds (e.g., α-methylstyrene, o-chlorostyrene, and vinyltoluene); isoprene; anhydrides of α,β-monoethylenically unsaturated monocarboxylic and dicarboxylic acids (e.g., maleic anhydride, itaconic anhydride, and methylmalonic anhydride); other alkyl-substituted acrylamides (e.g., N-tent-butylacrylamide and N-methyl(meth)acrylamide); vinyl and vinylidene halides (e.g., vinyl chloride and vinylidene chloride); vinyl esters of C₁-C₁₈ monocarboxylic or dicarboxylic acids (e.g., vinyl acetate, vinyl propionate, vinyl N-butyrate, vinyl laurate, and vinyl stearate); C₁-C₄ hydroxyalkyl esters of C₃-C₆ monocarboxylic or dicarboxylic acids, for example of acrylic acid, methacrylic acid, or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g., hydroxyethyl (meth)acrylate, hydroxypropyl (meth)acrylate, and methylpolyglycol acrylate); monomers containing glycidyl groups (e.g., glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3-(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP). In some embodiments, the one or more additional monomers include (meth)acrylonitrile, (meth)acrylamide, or a mixture thereof. In some embodiments, the polymer can include the one or more additional monomers in an amount of greater than 0% to 10% by weight, based on the weight of the polymer. For example, the polymer can include the one or more additional monomers in an amount of 0.5% to 10%, 0.5% to 5%, 0.5% to 4%, 0.5% to 3%, 0.5% to 2%, or 0.5% to 1% by weight, based on the weight of the polymer.

The polymer can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the polymer can include from 0.01% to 5% by weight of the polymer, of the crosslinking agent.

In some embodiments, the polymer in the asphalt composition can include styrene, butadiene, and optionally, one or more additional monomers. The styrene can be in an amount of 2% or greater by weight, based on the weight of the polymer. For example, the styrene can be in an amount of 5% or greater, 10% or greater, 20% or greater, 30% or greater, 40% or greater, 50% or greater, 60% or greater, or 70% or greater, by weight, based on the weight of the polymer. In some embodiments, the styrene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. The butadiene can be in an amount of 2% by weight of the polymer. For example, the butadiene can be in an amount of 5% or greater, 10% or greater, 20% or greater, 30% or greater, 40% or greater, 50% or greater, 60% or greater, or 70% or greater by weight, based on the weight of the polymer. In some embodiments, the butadiene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. In some embodiments, the weight ratio of styrene to butadiene monomers in the polymer can be from 1:99 to 99:1, from 20:80 to 80:20, from 30:70 to 70:30, or from 40:60 to 60:40. For example, the weight ratio of styrene to butadiene can be 25:75 or greater, 30:70 or greater, 35:65 or greater, or 40:60 or greater.

The styrene butadiene copolymer can include a carboxylic acid monomer. In some embodiments, the polymer can include a carboxylated styrene-butadiene copolymer derived from styrene, butadiene, and a carboxylic acid monomer. In some embodiments, the polymer can be derived from 0.5%-10%, 1-9%, or 2-8% by weight of a carboxylic acid monomer. Suitable carboxylic acid monomers include (meth)acrylic acid, itaconic acid, fumaric acid, or mixtures thereof. In some embodiments, the polymer can include a non-carboxylated styrene-butadiene copolymer (i.e., not derived from a carboxylic acid monomer). In some embodiments, the polymer includes one or more of the other monomers provided above.

In some embodiments, the polymer in the asphalt composition can be a styrene-butadiene copolymer. Suitable commercially available styrene-butadiene copolymers can include BUTONAL® NX1118, BUTONAL® NX 1138, BUTONAL® NX 4190, and BUTONAL® NS 198, commercially available from BASF Corporation.

The polymer in the asphalt compositions can be in an amount of 0.25% or greater by weight, based on the weight of the asphalt composition. In some embodiments, the asphalt composition can include the polymer in an amount of 0.25% or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, or 9% or greater by weight, based on the weight of the asphalt composition. In some embodiments, the asphalt composition can include the polymer in an amount of 10% or less, 8% or less, 7% or less, 6% or less, 5% or less, 4% or less, 3% or less, 2% or less, or 1% or less by weight, based on the weight of the asphalt composition. In some embodiments, the asphalt composition can include the polymer in an amount of 0.25% to 10%, 0.5% to 8%, 0.5% to 6%, 0.75% to 5%, or 0.75% to 4% by weight, based on the weight of the asphalt composition.

In some embodiments, the polymer can be in the form of a latex composition. The latex composition can be an aqueous dispersion including particles of the polymer dispersed in water. In some embodiments, the latex composition can be prepared with a total solids content of from 5% to 90% by weight, for example, 10% to 80% by weight, 20% to 70% by weight, 25% to 65% by weight, 35% to 60% by weight, or 45% to 60% by weight, based on the weight of the latex composition. In some embodiments, the latex composition can have a total solids content of 40% or greater or 50% or greater by weight, based on the weight of the latex composition. In some embodiments, the latex composition can have a total solids content of 90% or less, 80% or less, or 70% or less by weight, based on the weight of the latex composition. The polymer particles in the latex composition can have an average particle size of from 20 nm to 500 nm, such as from 20 nm to 400 nm, from 30 nm to 300 nm, or from 50 nm to 250 nm. The particle size of the polymer particles can be measured using dynamic light scattering measurements, for example using a Nicomp Model 380 available from Particle Sizing Systems, Santa Barbara, Calif.

The latex composition can be cationic, anionic, or non-ionic. In some embodiments, the latex composition can be cationic. For example, the latex composition can include a cationic surfactant such as an amine-containing surfactant at a suitable pH (e.g., below the pKa of the amine group in the cationic surfactant). In some embodiments, the latex composition can be anionic. For example, the latex composition can include a carboxylated polymer, such as a carboxylated styrene butadiene copolymer. In some embodiments, the latex composition (including the cationic, anionic, or non-ionic latex composition) can have a pH of 7 or less. For example, the latex composition can have a pH of 6.5 or less, 6 or less, 5.5 or less, 5 or less 4.5 or less 4 or less, or 3.5 or less. In some examples, the latex composition can have a pH of 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the latex composition can have a pH of from 2 to 7, from 2 to 6.5, from 2 to 6, from 3 to 7, from 3 to 6.5, from 3 to 6, from 4 to 7, from 4 to 6.5, or from 4 to 6.

The latex composition can include one or more surfactants (emulsifiers) such as nonionic surfactants, anionic surfactants, cationic surfactants, amphoteric surfactants, or a mixture thereof. In some embodiments, the latex compositions include an amine derived surfactant. Suitable surfactants include polyamines, fatty amines, fatty amido-amines, ethoxylated amines, diamines, imidazolines, quaternary ammonium salts, and mixtures thereof. Examples of commercially available surfactants that can be used in the latex composition include those available from Akzo Nobel under the REDICOTE® trademark (such as REDICOTE® 4819, REDICOTE® E-64R, REDICOTE® E-5, REDICOTE® E-9, REDICOTE® E9A, REDICOTE® E-11, REDICOTE® E-16, REDICOTE® E-44, REDICOTE® E-120, REDICOTE® E-250, REDICOTE® E-2199, REDICOTE® E-4868, REDICOTE® C-346, REDICOTE® C-404, REDICOTE® C-450, and REDICOTE® C-471), surfactants available from MeadWestvaco under the INDULIN® and AROSURF® trademarks (such as INDULIN® 814, INDULIN® AMS, INDULIN® DF-30, INDULIN® DF-40, INDULIN® DF-42, INDULIN® DF-60, INDULIN® DF-80, INDULIN® EX, INDULIN® FRC, INDULIN® MQK, INDULIN® MQK-1M, INDULIN® MQ3, INDULIN® QTS, INDULIN® R-20, INDULIN® SBT, INDULIN® W-1, and INDULIN® W-5), ASFIER® N480 available from Kao Specialties Americas, CYPRO™ 514 available from Cytec Industries, polyethyleneimines such as those available from BASF under the POLYMIN® trademark (such as POLYMIN® SK, POLYMIN® SKA, POLYMIN® 131, POLYMIN® 151, POLYMIN® 8209, POLYMIN® P, and POLYMIN® PL), and polyvinylamines such as those available from BASF under the CATIOFAST® trademark (such as CATIOFAST® CS, CATIOFAST® FP, CATIOFAST® GM, and CATIOFAST® PL).

The latex composition can include an antioxidant to prevent oxidation of, for example, the double bonds of the styrene butadiene polymer. Suitable antioxidants can include substituted phenols or secondary aromatic amines. The composition can include antiozonants to prevent ozone present in the atmosphere from, for example, cracking the styrene butadiene polymer, by cleaving the double bonds of the styrene butadiene polymer. The latex composition can include prevulcanization inhibitors to prevent premature vulcanization or scorching of the polymer. Suitable antioxidants, antiozonants, and prevulcanization inhibitors are disclosed in U.S. Pat. No. 8,952,092. The antioxidants, antiozonants, and/or prevulcanization inhibitors can be provided in an amount from 1% to 5% by weight, based on the weight of the solids in the latex composition.

The latex compositions described herein can include an inorganic acid. In some embodiments, the latex compositions can include an inorganic acid selected from hydrochloric acid, sulfuric acid, phosphoric acid, polyphosphoric acid, C₁-C₁₄ organic acids such as acetic acid, formic acid, citric acid, tartaric acid, and mixtures thereof. In some embodiments, the inorganic acid can be present in an amount of from 0.3% to 3% by weight, based on the total weight of the latex composition. For example, the latex composition can include 0.3% or greater, 0.5% or greater, 1% or greater, 1.5% or greater, 2% or greater, or 2.5% or greater by weight of the latex composition, of the inorganic acid. In some embodiments, the latex composition can include 3% or less, 2.5% or less, 2.0% or less, 1.5% or less, 1.0% or less, or 0.5% or less by weight of the latex composition, of the inorganic acid. In some embodiments, the latex composition can include from 0.3% to 3%, 0.5% to 3%, or 1% to 3% by weight of the latex composition, of the inorganic acid. In some embodiments, the inorganic acid can be in an amount such that the pH of the latex composition or asphalt compositions thereof, can be from 1 to 6, such as from 2 to 4 or from 3 to 5. The inorganic acid can be present in an amount of from 0.005% to 0.1% by weight, based on the total weight of the asphalt composition.

In some embodiments, the latex composition can include phosphoric acid. In some embodiments, the latex compositions can include phosphoric acid and polyphosphoric acid. The amount of phosphoric acid in the latex composition can be 0.1% by weight or greater, based on the total weight of the latex composition. For example, the latex composition can include 0.2% or greater, 0.3% or greater, 0.5% or greater, 0.6% or greater, 0.7% or greater, 0.8% or greater, 0.9% or greater, 1% or greater, 1.5% or greater, 2% or greater, 2.5% or greater, or 3% or greater by weight of the latex composition, of phosphoric acid. In some embodiments, the latex composition can include 3% or less, 2.5% or less, 2% or less, 1.5% or less, or 1% or less by weight of the latex composition, of phosphoric acid. In some embodiments, the latex composition can include from 0.3% to 3%, 0.5% to 3%, or 1% to 3% by weight of the latex composition, of phosphoric acid.

The amount of phosphoric acid in the asphalt composition can be 0.005% by weight or greater, based on the total weight of the asphalt composition. For example, the asphalt composition can include 0.01% or greater, 0.02% or greater, 0.03% or greater, 0.04% or greater, 0.05% or greater, 0.06% or greater, 0.07% or greater, 0.08% or greater, 0.09% or greater, or 0.1% or greater by weight of the asphalt composition, of phosphoric acid. In some embodiments, the asphalt composition can include 0.1% or less, 0.09% or less, 0.08% or less, 0.07% or less, 0.06% or less, 0.05% or less, 0.04% or less, 0.03% or less, 0.02% or less, 0.01% or less, 0.009% or less, 0.008% or less, 0.007% or less, or 0.005% or less by weight of the asphalt composition, of phosphoric acid. In some embodiments, the asphalt composition can include from 0.005 to 0.1%, or 0.01% to 0.1% by weight of the asphalt composition, of phosphoric acid.

The amount of latex composition used to produce the asphalt composition can be in an amount of 0.5% or greater by weight, based on the weight of the asphalt composition. In some embodiments, the asphalt composition can include the latex composition in an amount of 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, or 14% or greater by weight, based on the weight of the asphalt composition. In some embodiments, the asphalt composition can include the latex composition in an amount of 15% or less, 12% or less, 10% or less, 8% or less, 7% or less, 6% or less, 5% or less, 4% or less, 3% or less, 2% or less, or 1% or less by weight, based on the weight of the asphalt composition. In some embodiments, the asphalt composition can include the latex composition in an amount of 0.5% to 15%, 0.5% to 12%, 0.5% to 10%, 1% to 15%, or 1% to 10% by weight, based on the weight of the asphalt composition.

The asphalt compositions described herein can be vulcanized or cured to crosslink the polymer included in the asphalt composition, thereby increasing the tensile strength and elongation of the polymer. In some embodiments, the asphalt compositions can include vulcanizing (curing) agents, vulcanization accelerators, antireversion agents, or a combination thereof. In some embodiments, the vulcanizing (curing) agents, vulcanization accelerators, antireversion agents, or a combination thereof can be included in the latex composition. In some embodiments, the vulcanizing agents, vulcanization accelerators, and/or antireversion agents can be included in the asphalt composition. Exemplary vulcanizing agents are sulfur curing agents and include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. The vulcanizing agent can be present from 0.01 to 1% or from 0.01 to 0.6% by weight, based on the weight of the asphalt composition. In some embodiments, the asphalt compositions can include a sulfur containing curing agent such as sulfur dispersions or sulfur donors.

Exemplary vulcanization accelerators include sulfenamide-type vulcanization accelerators such as N-cyclohexyl-2-benzothiazole sulfenamide, N-t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N, N′-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present in an amount of from 0.01 to 1% or from 0.01 to 0.6% by weight, based on the weight of the asphalt compositions.

Antireversion agents can also be included to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N, N′-xylenedicitraconamides). The antireversion agent can be present in an amount of from 0.01 to 1% or from 0.01 to 0.6% by weight, based on the weight of the asphalt composition.

The asphalt compositions can include a solvent such as water to disperse or emulsify the polymer and/or the asphalt. The asphalt compositions can include water in an amount of 1% to 35%, 5% to 30%, or 5% to 25% by weight, based on the weight of the asphalt compositions.

The asphalt compositions can further include one or more additional additives. Suitable additional additives include chloride salts, thickeners, and fillers. Chloride salts can be added, for example to improve emulsifiability, in an amount of up to 1 part by weight. Suitable chloride salts include sodium chloride, potassium chloride, calcium chloride, aluminum chloride, or mixtures thereof. Thickeners can be added in an amount of 0.5 parts by weight or greater and can include associative thickeners, polyurethanes, alkali swellable latex thickeners, cellulose, cellulose derivatives, modified cellulose products, plant and vegetable gums, starches, alkyl amines, polyacrylic resins, carboxyvinyl resins, polyethylene maleic anhydrides, polysaccharides, acrylic copolymers, hydrated lime (such as cationic and/or nonionic lime), or mixtures thereof. In some embodiments, the asphalt compositions described herein do not include a thickener. Mineral fillers and/or pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides (e.g., titanium dioxide), aluminum hydroxide, aluminum trihydrate, satine white, magnesium oxide, hydrated lime, limestone dust, Portland cement, silica, alum, fly ash, or mixtures thereof. Fillers such as mineral fillers and carbon black can be included in an amount of up to 5 parts by weight or up to 2 parts by weight.

The asphalt compositions can also include an aggregate. The aggregate can be of varying sizes as would be understood by those of skill in the art. Any aggregate that is traditionally employed in the production of bituminous paving compositions can be used, including dense-graded aggregate, gap-graded aggregate, open-graded aggregate, reclaimed asphalt pavement, and mixtures thereof. In some embodiments, the asphalt compositions can include an aggregate in an amount of 1% to 90% by weight, based on the weight of the asphalt composition. In some embodiments, the asphalt compositions can include an aggregate in an amount of 90% or less, 85% or less, 80% or less, 75% or less, 70% or less, 65% or less, 60% or less, 55% or less, 50% or less, or 45% or less by weight, based on the weight of the asphalt composition. In some embodiments, the asphalt compositions can include an aggregate in an amount of 5% or greater, 10% or greater, 15% or greater, 20% or greater, 25% or greater, 30% or greater, 35% or greater, 40% or greater, 45% or greater, or 50% or greater by weight, based on the weight of the asphalt composition.

In some embodiments, the asphalt compositions can have a pH of 7 or less. For example, the asphalt composition can have a pH of 6.5 or less, 6 or less, 5.5 or less, 5 or less 4.5 or less 4 or less, 3.5 or less, 3 or less, or 2.5 or less. In some examples, the asphalt composition can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt composition can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

### Methods

Methods for preparing the asphalt emulsion compositions described herein are also provided. In some embodiments, the method can include preparing a latex composition of the polymer. A latex composition can be prepared by polymerizing monomers, such as styrene monomers, butadiene monomers, and optionally additional monomers in an aqueous emulsion polymerization reaction at a suitable temperature. The polymerization can be carried out at low temperature (i.e., cold polymerization) or at high temperature method (i.e., hot polymerization). In some embodiments, polymerization can be carried out at low temperature such as 30° C. or less (for example from 2° C. to 30° C., 2° C. to 25° C., 5° C. to 30° C., or 5° C. to 25° C.). In some embodiments, polymerization can be carried out at high temperature such as from 40° C. or greater, 50° C. or greater, or 60° C. or greater. In some embodiments, the high temperature can be from 40° C. to 100° C., 40° C. to 95° C., or 50° C. to 90° C.

The block-copolymer is added to the latex. The block copolymer may be added to the asphalt composition simultaneously with the addition of the latex. However, it is also possible to add the copolymer at a point in the asphalt emulsion preparation other than that of latex addition. In an optional embodiment, the block copolymer is the sole polymer modifier used in the asphalt emulsion. Put another way, in that embodiment no latex polymer is added, just block copolymer.

The polymerized polymer can be produced using either a continuous, semi-batch (semi-continuous) or batch process. In some examples, the polymer can be produced using a continuous method by continuously feeding one or more monomer streams, a surfactant stream, and an initiator stream to one or more reactors. The surfactant stream includes a surfactant and water and can, in some embodiments, be combined with the initiator stream.

The polymerization reaction can be conducted in the presence of molecular weight regulators to reduce the molecular weight of the copolymer of other additives such as dispersants, stabilizers, chain transfer agents, buffering agents, salts, preservatives, fire retardants, wetting agents, protective colloids, biocides, crosslinking promoters, antioxidants, antiozonants, prevulcanization inhibitors, and lubricants. In some embodiments, the additives can be added to the latex composition after the polymerization reaction. The latex composition can be agglomerated, e.g., using chemical, freeze or pressure agglomeration, and water removed to produce the desired solids content. In some embodiments, the solids content is 55% or greater, 60% or greater, or 65% or greater.

In some embodiments, the latex composition can have an overall anionic charge, non-ionic, or cationic charge. One of ordinary skill in the art understands that the overall charge of the latex composition can be influenced by the surfactant used, the particular monomers used to form the polymer in the latex composition, and the pH of the latex composition.

The method of preparing the asphalt emulsions can include contacting asphalt with a latex composition as described herein. In some embodiments, the latex composition is cationic. The method can further include contacting the asphalt with a basic salt, such as aluminum sulfate. The particular components, including the asphalt, the latex composition, and the basic salt in the asphalt emulsions can be mixed together by any means known in the art. The particular components can be mixed together in any order.

The particular components, including the asphalt, the latex composition, and the asphalt can be fed into a colloid mill at a temperature of less than 100° C. (e.g., 60° C. to 95° C.) where high shear mixing produces an asphalt emulsion having asphalt droplets dispersed in the water. The basic salt can be added simultaneously or the basic salt post-added to the asphalt emulsion (comprising the latex composition and asphalt). In some embodiments, the latex composition and the basic salt are mixed with the asphalt simultaneously. For example, the latex composition can include the basic salt such that the polymer, inorganic acid (if present), and the basic salt are simultaneously mixed with the asphalt. In some embodiments, the basic salt can be combined directly with the asphalt prior to mixing with the other ingredients.

The droplets in the asphalt emulsion can have a narrow particle size distribution. In some embodiments, the droplets in the asphalt emulsion can have a median particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a mean particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a median particle size of from 3 to 15 μm. In some embodiments, the droplets in the asphalt emulsion can have a median distribution of droplet particles having a standard deviation of less than 30%, less than 25%, less than 20%, less than 15%, or less than 10%. In some embodiments, the droplets in the asphalt emulsions comprising the phosphoric acid flipped cationic latex composition and/or aluminum sulfate can have a narrower particle size distribution than an asphalt emulsion that does not include the phosphoric acid flipped cationic latex composition and/or aluminum sulfate.

The asphalt emulsions can have a viscosity of 100 cp or greater, when the asphalt is present in an amount of 65% by weight, based on the asphalt emulsion, in the absence of a thickener. In the event the asphalt content is less than or greater than 65% by weight, the asphalt content can be adjusted by adding or removing water. In some embodiments, the asphalt emulsions can have a viscosity of 150 cp or greater, 200 cp or greater, 250 cp or greater, 300 cp or greater, 350 cp or greater, 400 cp or greater, 450 cp or greater, 500 cp or greater, 600 cp or greater, 700 cp or greater, 800 cp or greater, 900 cp or greater, 1000 cp or greater, 1500 cp or greater, 2000 cp or greater, or 2500 cp or greater, when the asphalt is present in an amount of 65% by weight, based on the asphalt emulsion. In some embodiments, the asphalt emulsions can have a viscosity of 2500 cp or less, 2000 cp or less, 1500 cp or less, 1250 cp or less, 1000 cp or less, 950 cp or less, 900 cp or less, 850 cp or less, 800 cp or less, 750 cp or less, 700 cp or less, 650 cp or less, 600 cp or less, 550 cp or less, 500 cp or less, 400 cp or less, 250 cp or greater, 300 cp or less, or 200 cp or less, when the asphalt is present in an amount of 65% by weight, based on the asphalt emulsion. In some embodiments, the viscosity of the asphalt emulsions can be from 100 cp to 2500 cp, for example, 100 cp to 1500 cp, 100 cp to 1000 cp, 100 cp to 800 cp, 100 cp to 600 cp, 100 cp to 500 cp, 200 cp to 1500 cp, 200 cp to 1000 cp, 200 cp to 800 cp, 200 cp to 600 cp, 200 cp to 500 cp, 100 cp to 500 cp, 100 cp to 450 cp, or 150 cp to 500 cp, when the asphalt is present in an amount of 65% by weight, based on the asphalt emulsion. In some embodiments, the addition of the phosphoric acid flipped cationic latex composition and/or aluminum sulfate to the asphalt emulsions can result in an increase in viscosity of 1 time or greater, 2 times or greater, 3 times or greater, 4 times or greater, 5 times or greater, 6 times or greater, or up to 10 times or greater, compared to an asphalt emulsion without the phosphoric acid flipped cationic latex composition and/or aluminum sulfate.

In some embodiments, the (polymer-modified) asphalt emulsion has a softening point that is 5° C. or greater, 10° C. or greater, or 15° C. or greater than the softening point of the same asphalt emulsion without the phosphoric acid and polyphosphoric acid. In some embodiments, the (polymer-modified) asphalt emulsion has a softening point that is 5° C. or greater, 10° C. or greater, or 15° C. or greater than the softening point of the same asphalt emulsion without the aluminum sulfate and polyphosphoric acid. In some embodiments, the (polymer-modified) asphalt emulsion has a softening point that is 5° C. or greater, 10° C. or greater, or 15° C. or greater than the softening point of the same asphalt emulsion without the phosphoric acid, the polyphosphoric acid and the aluminum sulfate. In some embodiments, the asphalt emulsion using a PG 58-28 base asphalt can have a softening point of 65° C. or greater (for example, 70° C. or greater, 75° C. or greater, or 80° C. or greater). In some embodiments, the asphalt emulsion using a PG 58-28 base asphalt can have a softening point of 85° C. or less (for example, 80° C. or less, 75° C. or less, or 70° C. or less). In some embodiments, the asphalt emulsion using a PG 58-28 base asphalt can have a softening point of from 65° C. to 85° C. or from 70° C. to 80° C. The Ring and Ball Softening Point test, such as those described in ASTM D36 and/or AASHTO T53, can be used to measure the temperature at which an asphalt composition becomes soft and flowable.

The asphalt emulsions described herein can adhere to the standards of ASTM D977, ASTM D2397, AASHTO M140, and AASHTO M208.

The latex composition can be used to prepare polymer modified hot mix asphalt compositions. A hot mix asphalt can be prepared, for example, by blending asphalt, a latex composition as described herein, and optionally a basic salt at a blending temperature exceeding the boiling point of water. In some embodiments, the latex composition can have a pH of 7 or less as described herein. In some embodiments, the latex composition can be anionic. For example, the latex composition can include a carboxylated polymer. In some embodiments, the latex composition can be nonionic. In some embodiments, the latex composition can be cationic, for example, by including a cationic surfactant. The blending temperature of the hot mix asphalt can be 150° C. or greater or 160° C. or greater and 200° C. or less. The hot mix asphalt composition is substantially free of water and can have, for example, a viscosity of 3000 cp or less, 2500 cp or less, 2000 cp or less, or 1500 cp or less at 135° C., when the asphalt is present in an amount of 95% by weight, based on the hot mix asphalt compositions. In some embodiments, the hot-mix asphalt composition can have a viscosity of 1000 cp or greater, 1250 cp or greater, 1500 cp or greater, 2000 cp or greater, or 2500 cp or greater, when the asphalt is present in an amount of 95% by weight, based on the hot mix asphalt compositions. In some embodiments, the viscosity of the hot-mix asphalt composition can be from 1000 cp to 3000 cp, for example, 1000 cp to 2500 cp, 1000 cp to 2000 cp, 1500 cp to 2500 cp, or 1500 cp to 2000 cp, when the asphalt is present in an amount of 95% by weight, based on the hot mix asphalt compositions. The latex composition can be in the amounts described above when added to the hot mix asphalt, but the resulting hot mix asphalt will include less of the latex composition because the water is evaporated leaving the latex polymer and any other non-volatile additives. For example, the latex polymer can be present in a hot mix asphalt composition in an amount of from 0.05 wt. % to 10 wt. % (e.g., from 0.5 wt. % to 3 wt. %), based on the weight of the hot mix asphalt composition. In some embodiments, the hot mix asphalt composition has a pH of 7 or less, or 6 or less (e.g., 1.5 to 6), as described herein.

In some embodiments, the hot mix asphalt composition has a softening point that is 5° C. or greater, 10° C. or greater, or 15° C. or greater than the softening point of the same hot mix asphalt composition without the phosphoric acid and polyphosphoric acid. In some embodiments, the (polymer-modified) hot mix asphalt composition has a softening point that is 5° C. or greater, 10° C. or greater, or 15° C. or greater than the softening point of the same hot mix asphalt composition without the aluminum sulfate and polyphosphoric acid. In some embodiments, the (polymer-modified) hot mix asphalt composition has a softening point that is 5° C. or greater, 10° C. or greater, or 15° C. or greater than the softening point of the same hot mix asphalt composition without the phosphoric acid the polyphosphoric acid and the aluminum sulfate. In some embodiments, the hot mix asphalt compositions can have a softening point of 75° C. or greater or 80° C. or greater using a PG 58-28 base asphalt.

Methods of using the asphalt compositions described herein are disclosed. The asphalt compositions can be applied to a surface to be treated, restored, or sealed. Prior to application of the asphalt composition, the surface to be treated is usually cleaned to remove excess surface dirt, weeds, and contaminants by, for example, brushing the surface, blasting the surface with compressed air, or washing the surface. The asphalt compositions can be applied using any suitable method for applying a liquid to a porous surface, such as brushing, wiping and drawing, or spraying.

In some embodiments, the asphalt compositions, once applied, wet the surface thereby forming a layer on at least a portion and typically at least a substantial portion (e.g. more than 50%) of the surface. In some embodiments, when asphalt emulsions are applied to a surface, water loss occurs in the emulsion, primarily due to adsorption of the water. The water also delivers the asphalt and the cationic latex composition to the surface. In some embodiments, the asphalt emulsion penetrates and adheres to the surface it is applied to, cures in a reasonably rapid time, and provides a water-tight and air-tight barrier on the surface. The asphalt emulsion layer also promotes adhesion between the older surface and the later applied surface treatment layer. It is desirable for the asphalt compositions to be easily applied and have an adequate shelf life.

An aggregate can be blended into the asphalt compositions before application to a surface. In some embodiments, the aggregate can be applied to the asphalt compositions after it is applied to a surface. For example, sand can be applied to the asphalt compositions after it is applied to a surface, for example, if the composition is to be used as a tack coat, to reduce the tackiness of the surface. The asphalt compositions and optionally the aggregate can be compacted after application to the surface as would be understood by those of skill in the art.

The asphalt compositions can be applied for use in a pavement or paved surface. A pavement surface or a paved surface is a hard surface that can bear pedestrian or vehicular travel can include surfaces such as motorways/roads, parking lots, bridges/overpasses, runways, driveways, vehicular paths, running paths, walkways, and the like. The asphalt compositions can be applied directly to an existing paved surface or can be applied to an unpaved surface. In some embodiments, the asphalt compositions can be applied to an existing paved layer as a tie layer, and a new layer comprising asphalt such as a hot mix layer is applied to the tie layer. The asphalt compositions can be applied to a surface “cold,” i.e., at a temperature below 40° C., or can be applied to at an elevated temperature, for example, from 50° C. to 120° C., from 55° C. to 100° C., or from 60° C. to 80° C.

In some embodiments, the asphalt compositions can be used as a tack coat or coating. The tack coat is a very light spray application of diluted asphalt emulsion that can be used to promote a bond between an existing surface and the new asphalt application. The tack coat acts to provide a degree of adhesion or bonding between asphalt layers, and in some instances, can fuse the layers together. The tack coat also acts to reduce slippage and sliding of the layers relative to other layers in the pavement structure during use or due to wear and weathering of the pavement structure. In some embodiments, the asphalt compositions can be applied to an existing paved layer (such as a hot-mix layer) as a tack coat, and a new layer comprising asphalt such as a hot-mix layer can be applied to the tack coat. As would be understood by those skilled in the art, the tack coat typically does not include aggregate, although sand may be applied to the tack coat after application as mentioned herein.

As described herein, the asphalt compositions cure/dry quickly. For example, where the asphalt compositions are used as a tack coating, the coating cures quickly such that a pavement layer may be applied to the coating, hours to days after the emulsion is applied to the substrate. In some embodiments, the applied composition can cure in 15 minutes to 45 minutes and may cure as rapidly as less than 1 minute to 15 minutes after the composition is applied to the exposed surface. The cure rate will depend on the application rate, the dilution ratios used, the base course conditions, the weather, and other similar considerations. If the prepared pavement surface or base course contains excess moisture, the curing time of the asphalt compositions may be increased.

In some embodiments, the asphalt compositions can also be used as a fog seal. A fog seal is a surface treatment that applies a light application of the composition to an existing paved surface such as a parking lot to provide an enriched pavement surface that looks fresh and black. In some embodiments, the fog seal would include a filler such as carbon black to blacken the composition. As would be understood by those skilled in the art, the fog seal might not include aggregate. The fog seal compositions, like the bond coat compositions, have also been shown to be to be low-tracking or “trackless” coatings.

In some embodiments, the asphalt compositions can be used as a chip seal composition. Chip seals are the most common surface treatment for low-volume roads. The chip seal composition can be applied to a surface followed by the application of aggregate. In some embodiments, the asphalt compositions can be used in a microsurfacing application. Microsurfacing is designed for quick traffic return with the capacity of handling high traffic volume roadways. For the microsurfacing composition, aggregate can be mixed in with the cationic asphalt composition before application to a surface.

In some embodiments, the asphalt compositions can be used in paints, coatings, paper coating or binding compositions, carpet compositions (e.g., carpet backing), foams, or adhesives.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

By way of non-limiting illustration, examples of certain embodiments of the present disclosure are given below.

### EXAMPLES

The following examples are put forth so as to provide those of ordinary skill in the art with a complete disclosure and description of how the compositions and/or methods claimed herein are made and evaluated and are intended to be purely exemplary and are not intended to limit the scope of the disclosure. Unless indicated otherwise, parts are parts by weight, temperature is in ° C. or is at ambient temperature, and pressure is at or near atmospheric.

### Preparation of the Block Copolymer

The production process of the amphiphilic block copolymers described below with A as initiator was carried out with 2,6-diethyl-2,3,6-trimethyl-1-(1-phenylethoxy)-4-piperidinone (hereinafter referred to as alkoxyamine A) as polymerization initiator.

### Example 1.1 A-Block 1.1: Synthesis of a Linear Polybutyl aAcrylate (BA)

Under nitrogen atmosphere 225 g of alkoxyamine A (0.71 mol) was dissolved in 4088 g n-butyl acrylate (31.9 mol). The mixture was degassed three times. Following which, it was heated to 115° C. and stirred at that temperature until desired monomer conversion was reached. Conversion was determined by solid content measurement according to ISO 3251. As soon as the targeted monomer conversion of n-butyl acrylate was obtained vacuum was applied and residual monomer was removed by vacuum distillation at 100° C. and 15 mbar. The solid content was >98%.

TABLE 1
A-Block preparation

| | | Alkoxyamine | nBA | Conver- | Average |
|---|---|---|---|---|---|
| | A- | A [g]/ | [g]/ | sion | repeating |
| Example | Block | [mol] | [mol] | [%] | units |
| 1.1 | 1.1 | 225/0.71 | 4088/31.9 | 44 | 20 |

nBA = n-butyl acrylate
alkoxyamine A = 2,6-diethyl-2,3,6-trimethyl-1-(1-phenylethoxy)-4-piperidinone

### Example 2.1: Synthesis of a Linear Block Copolymer poly(n-BA-b-NaSS)

Under nitrogen atmosphere 267 g sodium styrene sulfonate were dissolved in 3551 g N,N-dimethyl formamide (7% by weight NaSS) and 350 g of A-Block 1.1 was added The mixture was heated to 115° C. and stirred at that temperature until desired monomer conversion was reached. Conversion was determined by NMR measurement. As soon as full monomer conversion was obtained vacuum was applied and solvent removed by vacuum distillation at 155° C. and 5 mbar. The solid content was >99%

TABLE 2
Monomer compositions of the B-Block preparation

| | | | | | Average | Average |
|---|---|---|---|---|---|---|
| Example | | A- | A- | NaSS | repeating | repeating |
| No. = AB | A- | Block | Block | [g]/ | units A- | units B- |
| Block No. | Block | [g] | [mol] | [mol] | Block | Block |
| 2.1 | 1.1 | 350 | 0.117 | 267/1.29 | 20 | 10 |

### Latex Preparation Using Hot Polymerization

Styrene (50 parts by weight of the total monomers), tert-dodecyl mercaptan (0.1 to 2.0 parts by weight of the total monomers), butadiene (50 parts by weight of the total monomers), and an aqueous solution of sodium persulfate initiator (0.3 parts by weight of the total monomers), and the block-copolymer (0.1% by weight based on the total weight of the composition) were added over 6 hours to a pre-heated reactor (70° C.) initially containing water, sodium hydroxide (0.14 parts by weight of the total monomers), a polystyrene seed latex (1.66 parts by weight of the total monomers), and TRILON BX (0.03 parts by weight of the total monomers), an ethylenediaminetetraacetic acid commercially available from BASF Corporation (Florham Park, N.J.). The stabilization of the latex particles during polymerization was accomplished by feeding an aqueous solution of potassium oleate surfactant (3.6 parts by weight of the total monomers) over the course of the polymerization. The temperature was maintained at 70° C. throughout the polymerization reaction. Following the polymerization process, the latex dispersion was stripped of the residual monomers to provide an aqueous dispersion with residual styrene levels of less than 400 ppm.

### Latex-Modified Asphalt Sample Preparation

Asphalt cement was preheated to 160° C.+/−3° C. for at least two hours and then 650 grams of the heated asphalt cement was poured into a metallic can. The asphalt-containing can was heated to 170° C.+/−3° C. using a heating mantle. A blade was inserted at an angle at approximately 20 degrees in the middle of the can to provide optimum mixing. The latex prepared according to the method described above was added slowly to the hot asphalt with mixing at 300-325 rpm. Unless otherwise specified, the amount of latex polymer solids added to the asphalt was 3 wt. % based on the total solids content of the latex polymer and asphalt. After each addition, time was allowed for most of the bubbling to cease and then the mixer speed was increased to approximately 400-700 rpm to blend the resulting mixture. After latex addition, the mixing was continued for two additional hours to achieve an equilibrated asphalt polymer mixture. Samples of the polymer modified asphalts were taken for viscosity measurement or poured into molds for any desired testing.

### Direct Incorporation of Block-Copolymer into Asphalt Sample Preparation

Asphalt cement was preheated to 160° C.+/−3° C. for at least two hours and then 650 grams of the heated asphalt cement was poured into a metallic can. The asphalt-containing can was heated to 170° C.+/−3° C. using a heating mantle. A blade was inserted at an angle at approximately 20 degrees in the middle of the can to provide optimum mixing. The block-copolymer according to the method described above was added to the SBR latex and the SBR latex containing the block copolymer was added slowly to the hot asphalt with mixing at 300-325 rpm. Unless otherwise specified, the amount of block-polymer solids added to the asphalt was 3 wt. % based on the total solids content of the asphalt composition. After each addition, time was allowed for most of the bubbling to cease and then the mixer speed was increased to approximately 400-700 rpm to blend the resulting mixture. After the addition of the latex/block copolymer blend, the mixing was continued for two additional hours to achieve an equilibrated asphalt polymer mixture. Samples of the polymer-modified asphalts were taken for viscosity measurement or poured into molds for any desired testing.

### Determination of Particle Sizes

The distribution of particle size is determined by quasi-elastic light scattering (QELS), also known as dynamic light scattering (DLS) according to ISO 13321:1996 standard. The determination was carried out using High-Performance Particle Sizer (Malvern) at 22° C. and a wavelength of 633 nm. For this purpose, a sample of the aqueous polymer dispersion is diluted and the dilution is analyzed. In the context of DLS, the aqueous dilution may have a polymer concentration in the range from 0.001 to 0.5% by weight, depending on the particle size. For most purposes, a proper concentration will be 0.01% by weight. The reported particle size values in Table 1 are the z-average of the cumulant evaluation of the measured of the measured autocorrelation function.

TABLE 1
Average particle size of asphalt emulsion with
[BN 4190 + 3 parts BCP CGPS244A].

| | E-1921-21 | E-1921-21 |
|---|---|---|
| Emulsion Particle Size | (BN 4190) | (BN 4190 + 3% BCP) |
| Particle Size, ave, microns | 6.42 | 13.09 |
| SD | 10.66 | 7.32 |

Table 1 demonstrates the emulsion droplet size is much narrower with 3% BCP compared to the BN 4190 control. The addition of the block copolymer to the SBR Latex results in an increase of the asphalt droplet particle size and narrower particle size distribution.

### Sweep Testing Asphalt Emulsions

The ASTM D-7000 Standard Test Method for Sweep Test of Bituminous Emulsion Surface Treatment Samples was used to evaluate the emulsions prepared according to the methods described above. This test method measures the curing performance characteristics of bituminous emulsion and aggregates by simulating the brooming of a surface treatment in the laboratory.

TABLE 2
Sweep testing asphalt emulsions with [BN
4190 + 3 parts BCP CGPS244A].

| Sweep Testing −35 | E-1892-21 | E1893-21 | E-1921-21 |
|---|---|---|---|
| ° C. / 2 hours | (BN 4190) | (BN 4190) | (BN 4190 + 3% BCP) |
| ASTM D-7000 mod. | 9.31 | 13.70 | 4.16 |
| % loss | | | |

Table 2 demonstrates significantly improved sweeps with the 3% BCP additive compared to the BN 4190 control. It was surprisingly found that the curing performance characteristics of the asphalt emulsion treated with the block-copolymer additive were improved.

### Elastic Recovery of Latex Polymer-Modified Asphalt

The elastic recovery of latex polymer-modified asphalt binders prepared according to the methods described above were measured using a ductilometer according to a modified ASTM D6084 Procedure B testing protocol.

TABLE 3
Elastic recovery of asphalt emulsions with [BN
4190 + 3 parts BCP CGPS244A].

| Elastic Recovery, % | BN 4190 | BN 4190 with BCP |
|---|---|---|
| | 76.25 | 73.75 |
| | 76.25 | 73.75 |
| | 77.50 | 73.75 |
| Average | 76.7 | 73.8 |

Table 3 shows that the elastic recovery decreased slightly with the addition of the 3% block copolymer (BCP) additive but is well above the typical 50% minimum requirement.

### Softening Point of Latex Polymer-Modified Asphalt

The softening points of latex polymer-modified asphalt binders prepared according to the methods described above were measured using a ring-and-ball apparatus according to the ASTM D36 testing protocol.

TABLE 4
Softening point of asphalt emulsions with [BN
4190 + 3 parts BCP CGPS244A].

| Softening Point, ° F. | BN 4190 | BN 4190 with BCP |
|---|---|---|
| | 147.8 | 151.9 |
| | 152.4 | 158.4 |
| Average | 150.1 | 155.2 |

Table 4 shows higher softening point with addition of BCP. The softening point is indicative of the tendency of the emulsion to flow at elevate temperatures. This surprising result suggests better aggregate coverage for the asphalt emulsion modified with the block copolymer dispersant additive to BN 4190.

### Penetration Testing of Asphalt Emulsions

The asphalt emulsions prepared according to the methods described above were penetration tested according to the ASTM D-5 protocol. A measurement of the penetration was made by inserting a standard needle into the asphalt binder under the following conditions:
Load=100 grams
Temperature=25° C.
Time=5 seconds
   The depth of penetration is measured in units of dmm.

TABLE 5
Penetration of asphalt emulsions with [BN
4190 + 3 parts BCP CGPS244A].

| Penetration, dmm | BN 4190 | BN 4190 with BCP |
|---|---|---|
| | 86 | 92 |
| | 82 | 88 |
| | 84 | 88 |
| Average | 84 | 89.3 |

Table 5 shows higher penetration with addition of BCP. Penetration testing is used as a measure of consistency with higher values indicating softer consistency. It was surprisingly found that the addition of BCP resulted in softer consistency which is advantageous for reasons of ductility and temperature susceptibility.

In addition, and most surprisingly, the addition of block copolymer to styrene-butadiene rubber latexes, such as BN 4190 results in the simultaneous improvement of both the softening point and the penetration of the polymer modified asphalt emulsion. This is surprising because, typically, as the softening point of the asphalt increases, penetration decreases.

1-26. (canceled)

27. An asphalt emulsion composition comprising
a) asphalt,
b) a block-copolymer in an amount of from about 0.003% to 3% by weight based on the weight of the asphalt emulsion; and
c) water.
wherein the block copolymer has a first block comprising of alkyl acrylate and a second block comprising units of an ethylenically unsaturated monomer with sulfonic acid groups.

28. The asphalt emulsion of claim 27, wherein block-copolymer is present in an amount of from about 0.01% to 1% by weight based on the weight of the asphalt emulsion.

29. The asphalt emulsion of claim 27, wherein the block-copolymer is present in an amount of from about 0.1% to 1% by weight based on the weight of the asphalt emulsion.

30. The asphalt emulsion of claim 27, wherein the block-copolymer is present in an amount of about 0.1% by weight based on the weight of the asphalt emulsion.

31. The asphalt emulsion of claim 27, wherein the asphalt is present in an amount of from 50% to 99.9% by weight based on the weight of the asphalt emulsion.

32. The asphalt emulsion of claim 27, wherein the block copolymer comprises a polybutyl acrylate hydrophobic block and a sodium polystyrene sulfonate hydrophilic block.

33. The asphalt emulsion of claim 32, wherein the block copolymer's polybutyl acrylate to sodium polystyrene sulfonate ratio is 75/25 by weight.

34. The asphalt emulsion of claim 32, wherein the block-copolymer has a molecular weight exceeding 5000 g/mol.

35. The asphalt emulsion of claim 27, wherein the block-copolymer is a block-copolymer of formula (III):
X—[A]ₐ—[B]_{b}—Z (III), wherein
[A] is polymer block composed of an alkyl acrylate, and
a is an integer which indicates the number of monomers units in the polymer block [A], a being 10 to 80,
[B] is a homopolymer block or a copolymer block composed of an ethylenically unsaturated monomer with sulfonic acid groups, and optional comonomers and
b is an integer which indicates the number of monomers units in the polymer block [B], b being 10 to 80, with the proviso that the molar ratio of polymer block [A] to polymer block [B] is 1:1 to 8:1,
X is selected from the group consisting of —CH₂-phenyl, —CHCH₃-phenyl, —C(CH₃)₂-phenyl, —C(C₅-C₆-cycloalkyl)₂—CN, —C(CH₃)₂CN, —CH₂CH═CH₂, —CH₃CH—CH═CH₂, —(C₁-C₄alkyl)CR⁷—C(O)-phenyl, —(C₁-C₄)alkyl-CR⁷—C(O)—(C₁-C₄)alkoxy, —(C₁-C₄)alkyl-CR⁷—C(O)—(C₁-C₄)alkyl, —(C₁-C₄)alkyl-CR⁷—C(O)-—N-di(C₁-C₄)alkyl, —(C₁-C₄)alkyl-CR⁷—C(O)—NH(C₁-C₄)alkyl, and —(C₁-C₄)alkyl-CR⁷—C(O)—NH₂, wherein
R⁷ is hydrogen or (C₁-C₄)alkyl and
Z is a terminal group of formula Z 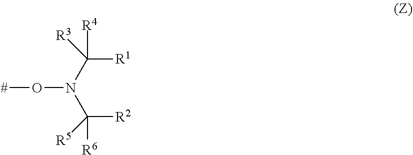
in which:
# denotes attachment to a C atom of B,
R¹ and R² independently of one another are C₁-C₂₀ alkyl which optionally carries substituent selected from C₁-C₄ alkoxy, C₁-C₄ alkoxy-C₁-C₄ alkoxy and PO₃R^{z}₂, and R^{z} is C₁-C₄ alkyl, or are phenyl or are C₇-C₁₈ aralkyl or R¹ and R² together are linear C₂-C₁₀ alkylene or linear C₂-C₁₀ alkenylene in which optionally one or two CH₂ groups may have been independently of another replaced by O, C═O, C═NOH, CH—OCOCH₃ or NR^{x}, where linear C₂-C₁₀ alkylene and linear C₂-C₁₀ alkenylene are unsubstituted or have 1, 2, 3, 4 or 5 substituents from the group C₁-C₄ alkyl, C₁-C₄ alkoxy, C₁-C₄ alkoxy-C₁-C₄ alkoxy, COOH, and CONH₂, and R^{x} is C₁-C₄ alkyl or C₁-C₄ alkoxy;
R³ is C₁-C₄ alkyl or H,
R⁴, R⁵, and R⁶ independently of one another are C₁-C₄ alkyl.

36. The asphalt composition according to claim 35, wherein:
[A] is polymer block composed of n-butylacrylate, and
[B] is a homopolymer block or a copolymer block composed of sodium styrene sulfonic acid, and optional comonomers.

37. The asphalt composition according to claim 35, wherein:
a) is 10 to 40.

38. The asphalt composition of claim 27 used in a tack coat.

39. The asphalt composition of claim 27 used in a fog seal.

40. The asphalt composition of claim 27 used in a chip seal.

41. The asphalt composition of claim 27 used in polymer-modified hot mix asphalt applications.

42. A method of forming the composition of claim 271, comprising, contacting a cationic or an anionic or nonionic latex composition comprising a block-copolymer and mixing the cationic or anionic or non-ionic latex composition comprising a block-copolymer, asphalt, and optionally water to form a mixture.

43. A method of forming the composition of claim 27, comprising, mixing a block-copolymer, asphalt, and optionally water to form a mixture.

44. The method of claim 42, wherein the cationic or anionic or nonionic latex composition is a cationic latex composition.

45. The method of claim 42, wherein the cationic or anionic or nonionic latex composition is an anionic latex composition.

46. The method of claim 42, wherein the cationic or anionic or nonionic latex composition is a non-ionic latex composition

47. A block-copolymer of formula (III):
X—[A]ₐ—[B]_{b}—Z (III), wherein
[A] is polymer block composed of an alkyl acrylate, and
a is an integer which indicates the number of monomers units in the polymer block [A], a being 10 to 80,
[B] is a homopolymer block or a copolymer block composed of an ethylenically unsaturated monomer with sulfonic acid groups, and optional comonomers and
b is an integer which indicates the number of monomers units in the polymer block [B], b being 10 to 80, with the proviso that the molar ratio of polymer block [A] to polymer block [B] is 1:1 to 8:1,
X is selected from the group consisting of —CH₂-phenyl, —CHCH₃-phenyl, —C(CH₃)₂-phenyl, —C(C₅-C₆-cycloalkyl)₂—CN, —C(CH₃)₂CN, —CH₂CH═CH₂, —CH₃CH—CH═CH₂, —(C₁-C₄alkyl)CR⁷—C(O)-phenyl, —(C₁-C₄)alkyl-CR⁷—C(O)—(C₁-C₄)alkoxy, —(C₁-C₄)alkyl-CR⁷—C(O)—(C₁-C₄)alkyl, —(C₁-C₄)alkyl-CR⁷—C(O)—N-di(C₁-C₄)alkyl, —(C₁-C₄)alkyl-CR⁷—C(O)—NH(C₁-C₄)alkyl, and —(C₁-C₄)alkyl-CR⁷—C(O)—NH₂, wherein
R⁷ is hydrogen or (C₁-C₄)alkyl and
Z is a terminal group of formula Z 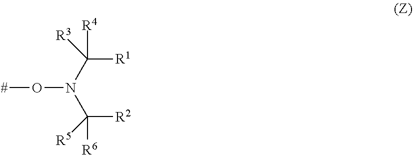
in which:
# denotes attachment to a C atom of B,
R¹ and R² independently of one another are C₁-C₂₀ alkyl which optionally carries substituent selected from C₁-C₄ alkoxy, C₁-C₄ alkoxy-C₁-C₄ alkoxy and PO₃R^{z}₂, and R^{z} is C₁-C₄ alkyl, or are phenyl or are C₇-C₁₈ aralkyl or R¹ and R² together are linear C₂-C₁₀ alkylene or linear C₂-C₁₀ alkenylene in which optionally one or two CH₂ groups may have been independently of another replaced by O, C═O, C═NOH, CH—OCOCH₃ or NR^{x}, where linear C₂-C₁₀ alkylene and linear C₂-C₁₀ alkenylene are unsubstituted or have 1, 2, 3, 4 or 5 substituents from the group C₁-C₄ alkyl, C₁-C₄ alkoxy, C₁-C₄ alkoxy-C₁-C₄ alkoxy, COOH, and CONH₂, and R^{x} is C₁-C₄ alkyl or C₁-C₄ alkoxy;
R³ is C₁-C₄ alkyl or H,
R⁴, R⁵, and R⁶ independently of one another are C₁-C₄ alkyl.

48. A styrene-butadiene latex made by emulsion polymerization using the block-copolymer of claim 47, wherein the styrene and butadiene monomers are in a weight ratio of styrene to butadiene of from 20:80 to 80:20.

49. A styrene-butadiene latex made by emulsion polymerization using the block-copolymer of claim 47, wherein the latex is cold-polymerized.

50. A styrene-butadiene latex made by emulsion polymerization using the block-copolymer of claim 47, wherein the latex is hot-polymerized.

51. A hot-mix asphalt composition comprising the styrene-butadiene latex formed according to claim 48.

52. An asphalt emulsion composition comprising the styrene-butadiene latex formed according to claim 48.
